(19) United States
(12) Patent Application Publication
(10) Pub. No.: US 2015/0300316 A1
(43) Pub. Date: Oct. 22, 2015

(54) ROTOR BLADE FOR A WIND TURBINE

(71) Applicant: WEPFER TECHNICS AG, Andelfingen (CH)

(72) Inventor: Hans WEPFER, Berg-Daegerlen (CH)

(73) Assignee: WEPFER TECHNICS AG, Andelfingen (CH)

(21) Appl. No.: 14/439,163

(22) PCT Filed: Oct. 29, 2013
(86) PCT No.: PCT/CH2013/000188

§ 371 Date: Apr. 28, 2015

(30) Foreign Application Priority Data
Oct. 29, 2012 (CH) 2171/12

(51) Int. Cl. F03D 1/06

(52) U.S. Cl. CPC F03D 1/0633

(57) ABSTRACT

The present invention relates to a rotor blade and to a corresponding rotor of a wind turbine with a reduced rotor diameter and increased performance. The rotor blade for a wind turbine has a wing root with a defined first diameter as an attachment to a hub, and a rotor blade end which is opposite the wing root, with a second defined diameter. Said rotor blade furthermore has a trailing edge and a leading edge with respect to the slicing direction of the rotor blade during operation. The leading edge and the trailing edge each have a curvature. The first diameter is smaller than the second diameter.

### TECHNICAL FIELD

The present invention relates to a rotor blade and to a corresponding rotor for wind turbines.

### PRIOR ART

Long, very slender rotor blades for 3-wing wind turbines have long been known. In order to obtain greater performances, the rotor blades to date have become longer and the rotor circle greater. This increases the moment of inertia which, in turn, results in it scarcely being possible any more to make use of gusts of wind. It is also not possible to suppress blade tip noises. The production and maintenance costs remain very high.

It is therefore an object of the invention to provide a rotor blade and a corresponding rotor having considerably shorter rotor blades and a narrower rotor circle associated therewith. In particular, the intention is to provide a rotor blade and a rotor, the structural configuration of which saves on material and maintenance costs.

### SUMMARY OF THE INVENTION

The achievement of the object is defined by the features of the independent claims.

One aspect of the present invention relates to a rotor blade for a wind turbine. The rotor blade has a wing root as an attachment to a hub, with a defined first diameter, and a rotor blade end which is opposite the wing root, with a defined second diameter. In addition, the rotor blade has a trailing edge and a leading edge with respect to the slicing direction, i.e. the direction in which the rotor blade rotates during operation, wherein the leading edge and the trailing edge each have a curvature. Said first diameter of the rotor blade is smaller than the second diameter.

In a particular embodiment, the diameter of the rotor blade increases from the first diameter at the wing root as far as the second diameter at the rotor blade end. Within the context of the present invention, this means that the diameter increases from the wing root outward to the rotor blade end.

In a particular embodiment, the rotor blade has a rotor camber axis which runs in such a manner that the leading edge, in front view, has a first camber height at the wing root that is lower than a central camber height in the center of the rotor blade that, in turn, is higher than an end-side camber height at the rotor blade end.

In an alternative particular embodiment, the rotor blade has an alternative rotor camber axis which runs in such a manner that the leading edge, in front view, has a first camber height at the wing root that is in particular substantially the same height as a central camber height in the center of the rotor blade that, in turn, is higher than an end-side camber height at the rotor blade end.

In a further alternative particular embodiment, the rotor blade has a rotor camber axis which runs in such a manner that the leading edge, in front view, has a first camber height at the wing root that is higher than a central camber height in the center of the rotor blade that, in turn, is higher than an end-side camber height at the rotor blade end.

In a particular embodiment, the rotor blade end comprises a double winglet.

In a particular embodiment, the rotor blade end comprises a winglet on the upper side of the profile.

In a particular embodiment, the rotor blade end comprises a winglet on the inner side of the profile.

In a particular embodiment, the rotor blade is manufactured from an aluminum plate, in particular said rotor blade is composed of aluminum.

In a particular embodiment, the rotor blade is manufactured from composite material, in particular said rotor blade is composed of composite material.

A further aspect of the present invention relates to a rotor comprising at least one rotor blade described at the beginning. The rotor is equipped with two to sixteen such rotor blades which are connected via the wing roots thereof to a hub.

### BRIEF DESCRIPTION OF THE DRAWINGS

Further advantageous embodiments and combinations of features of the invention will become apparent from the detailed description given below and from all of the patent claims.

The performance compensation of said comparatively smaller rotor is explained in more detail below with reference to the drawing. In the drawings used to illustrate the exemplary embodiment:

FIG. 1 shows a top view of a rotor blade according to the invention;

FIG. 2 shows a front view of a rotor blade according to the invention;

FIG. 3 shows a rotor blade end in side view with a double winglet;

FIG. 4 shows a rotor blade end in front view with a double winglet;

FIG. 5 shows a rotor blade end in side view with a winglet on the upper side of the profile;

FIG. 6 shows a rotor blade end in front view with a winglet on the upper side of the profile;

FIG. 7 shows a rotor blade end in side view with a winglet on the inner side of the profile, and

FIG. 8 shows a rotor blade end in front view with a winglet on the inner side of the profile.

In principle, identical parts are provided with identical reference signs in the figures.

### WAYS OF IMPLEMENTING THE INVENTION

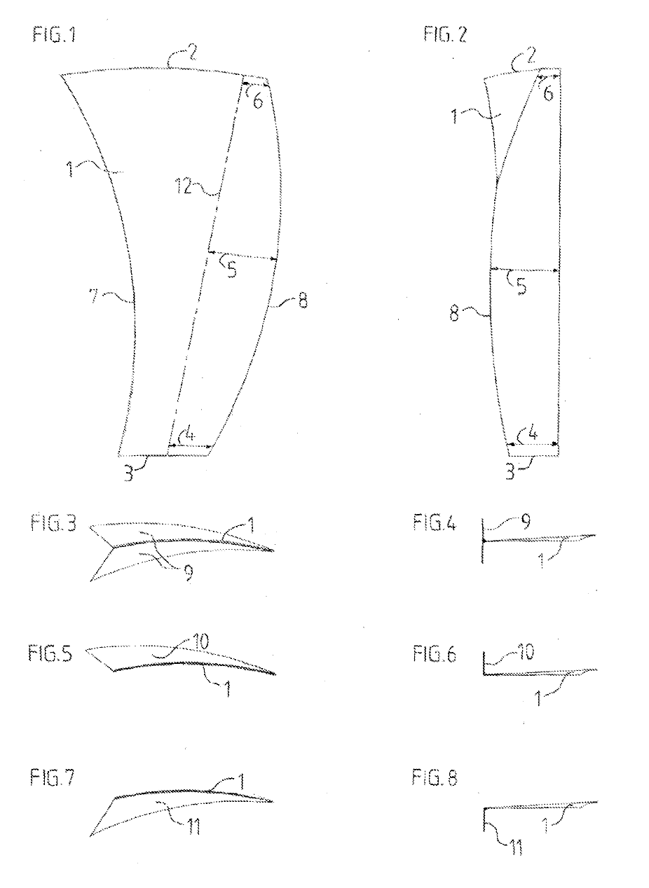

FIG. 1 shows a rotor blade 1 where, according to the invention, the trailing edge 7 and the leading edge 8 are provided with a radius, that is to say, leading edge 8 and trailing edge 7 each have a curvature. The curvature extends in a sickle-shaped manner from a wing root 3, and therefore the rotor blade 1 is produced in the shape of a scythe. The diameter of the rotor blade 1 at the wing root 3 is shorter than the diameter of the rotor blade 1 at the rotor blade end, that is to say, the depth of the rotor blade increases outward. In other words, the rotor blade I shown involves a sickle shape which is wider toward the outside, that is to say at the end facing away from a hub (not shown) than at the hub-side end. The rotor blade end 2 likewise has a curvature. The respective curvatures of the leading edge 8 and of the trailing edge 7 do not run parallel to each other, but rather are increasingly remote from each other over the course of the distance from the wing root 3.

In addition, the rotor blade shown has a camber. A rotor blade camber axis 12 with the corner values thereof, and with the first camber height 4, the central camber height 5 and the end-side camber height 6 defines the shape here of the rotor blade 1.

The camber of the rotor blade according to the invention can be seen better in FIG. 2. The latter shows a front view of a rotor blade 1, that is to say, as viewed from the direction into which the rotor blade moves during operation, where it is apparent that the leading edge 8 becomes shallower outward toward the rotor blade end 2, i.e. becomes less high. The end-side camber height 6 is lower in comparison to the central camber height 5. The central camber height 6 is higher in comparison to the first camber height 4 at the wing root 3.

FIGS. 3 and 4 show a double winglet 9 at the rotor blade end 2 where an outflow of air on the inside and also on the upper side is prevented over the entire rotor blade end 2.

FIGS. 5 and 6 show a winglet 10 on the rotor blade end where the outflow of air is prevented over the entire upper side of the profile.

FIGS. 7 and 8 show a winglet 11 on the rotor blade end 2 where the outflow of air is prevented over the entire inner side of the profile.

1. A rotor blade for a wind turbine, comprising
a) a wing root as an attachment to a hub, with a first diameter, and
b) a rotor blade end which is opposite the wing root, with a second diameter, and
c) a trailing edge and a leading edge with respect to the slicing direction of the rotor blade during operation, and wherein the leading edge and the trailing edge each have a curvature, and characterized in that the first diameter is smaller than the second diameter.

2. The rotor blade as claimed in claim 1, wherein the diameter of the rotor blade increases from the first diameter at the wing root as far as the second diameter at the rotor blade end.

3. The rotor blade as claimed in claim 1, wherein the rotor blade has a rotor camber axis which runs in such a manner that the leading edge, in front view, has a first camber height at the wing root that is lower than a central camber height in the center of the rotor blade that, in turn, is higher than an end-side camber height at the rotor blade end.

4. The rotor blade as claimed in claim 1, wherein the rotor blade has a rotor camber axis which runs in such a manner that the leading edge, in front view, has a first camber height at the wing root that is in particular substantially the same height as a central camber height in the center of the rotor blade that, in turn, is higher than an end-side camber height at the rotor blade end.

5. The rotor blade as claimed in claim 1, wherein the rotor blade has a rotor camber axis which runs in such a manner that the leading edge, in front view, has a first camber height at the wing root that is higher than a central camber height in the center of the rotor blade that, in turn, is higher than an end-side camber height at the rotor blade end.

6. The rotor blade as claimed in claim 1, wherein the rotor blade end comprises a double winglet.

7. The rotor blade as claimed in claim 1, wherein the rotor blade end comprises a winglet on the upper side of the profile.

8. The rotor blade as, claimed in claim 1, wherein the rotor blade comprises a winglet on the inner side of the profile.

9. The rotor blade as claimed in claim 1, wherein the rotor blade is manufactured from an aluminum plate, in particular is composed of aluminum.

10. The rotor blade as claimed in claim 1, wherein the rotor blade is manufactured from composite material, in particular is composed of composite material.

11. A rotor comprising at least one rotor blade as claimed in claim 1, wherein the rotor comprises two to sixteen such rotor blades.

12. The rotor blade as claimed in claim 2, wherein the rotor blade has a rotor camber axis which runs in such a manner that the leading edge, in front view, has a first camber height at the wing root that is lower than a central camber height in the center of the rotor blade that, in turn, is higher than an end-side camber height at the rotor blade end.

13. The rotor blade as claimed in claim 2, wherein the rotor blade has a rotor camber axis which runs in such a manner that the leading edge, in front view, has a first camber height at the wing root that is in particular substantially the same height as a central camber height in the center of the rotor blade that, in turn, is higher than an end-side camber height at the rotor blade end.

14. The rotor blade as claimed in claim 2, wherein the rotor blade has a rotor camber axis which runs in such a manner that the leading edge, in front view, has a first camber height at the wing root that is higher than a central camber height in the center of the rotor blade that, in turn, is higher than an end-side camber height at the rotor blade end.
